(19) United States
(12) Patent Application Publication
(10) Pub. No.: US 2015/0077381 A1
(43) Pub. Date: Mar. 19, 2015

(54) METHOD AND APPARATUS FOR CONTROLLING DISPLAY OF REGION IN MOBILE DEVICE

(71) Applicant: QUALCOMM Incorporated, San Diego, CA (US)

(72) Inventors: Min-Kyu Park, Seoul (KR); Kang Kim, Seoul (KR); Minsub Lee, Seoul (KR)

(73) Assignee: QUALCOMM Incorporated, San Diego, CA (US)

(21) Appl. No.: 14/031,885

(22) Filed: Sep. 19, 2013

(51) Int. Cl. G06F 3/01; G06F 3/041

(52) U.S. Cl. CPC G06F 3/013; G06F 3/0414
USPC 345/174

(57) ABSTRACT

According to an aspect of the present disclosure, a method for controlling display of a region on a touch screen display of a mobile device is disclosed. The method includes receiving a command indicative of zooming by a first sensor, sensing at least one image including at least one eye by a camera, determining a direction of a gaze of the at least one eye based on the at least one image, determining a target region to be zoomed on the touch screen display based on the direction of the gaze, and zooming the target region on the touch screen display.

### TECHNICAL FIELD

The present disclosure relates generally to controlling display of a region in a mobile device, and more specifically, to controlling display of a region in a display of a mobile device in response to a command received by a sensor.

### BACKGROUND

Recently, mobile devices such as smartphones, tablet computers, etc. have become popular among users. Such mobile devices generally include a touch screen display for operating the devices and displaying information. The touch screen display is typically configured to receive inputs from a user and output information on the touch screen display. In using such a mobile device, users may find it convenient to hold the device in one hand and operate the device by touching the touch screen display using the thumb of the same hand.

Some conventional mobile devices may be designed to be held in one hand and thus include a relatively small touch screen display due to the limitation on the size of such mobile devices. In such mobile devices, however, it may be difficult to touch a small object or region (such as small buttons, checkboxes, or hyperlinks between texts) with a finger in an accurate manner. For example, a region on the touch screen display that a user actually touches may not accurately match an object or region of interest that the user intends to touch due to the small size of the object or region of interest. In addition, a touch area of the user's fingertip may be larger than the object or region of interest. In response to such a touch operation, a mobile device may perform an operation that is not intended by the user.

Other mobile devices such as phablet devices and tablet computers typically include a relatively large touch screen display. In such a mobile device with a large screen size, it may be difficult for users to touch certain regions of the touch screen display using the fingers of one hand while holding the mobile device in the same hand. For example, when the user is holding a tablet computer, the user may not be able to touch regions of the display screen beyond the reach of his or her fingers of the same hand. In the case of a phablet device or a smartphone with a display screen smaller than a tablet device, users may not be able to reach some regions of the display screen such as corner regions. Accordingly, the users may need to change the grip on the mobile devices to extend the reach of their fingers to reach a desired region or use the other hand to touch the desired region of the display. In either case, the users may find it inconvenient to adjust the grip or use both hands to reach the desired region of the touch screen display.

### SUMMARY

The present disclosure relates to controlling display of a region in a display of a mobile device in response to a command received by a sensor.

According to one aspect of the present disclosure, a method for controlling display of a region on a touch screen display of a mobile device is disclosed. In this method, a command indicative of zooming is received by a first sensor. At least one image including at least one eye is sensed by a camera. Further, a direction of a gaze of the at least one eye is determined based on the at least one image. Based on the direction of the gaze, a target region to be zoomed on the touch screen display is determined Then, the target region on the touch screen display is zoomed. This disclosure also describes an apparatus, a device, a system, a combination of means, and a computer-readable medium relating to this method.

According to another aspect of the present disclosure, a mobile device configured to control display of a region in the mobile device is disclosed. The mobile device includes a first sensor, a command recognition unit, a camera, a gaze detection unit, a touch screen display, and a display controller. The first sensor is configured to receive an input indicative of a command to zoom. The command recognition unit is configured to recognize the command to zoom based on the input. The camera is configured to sense at least one image including at least one eye. The gaze detection unit is configured to determine a direction of a gaze of the at least one eye based on the at least one image. The touch screen display includes a touch screen sensor. The display controller is configured to determine a target region to be zoomed on the touch screen display based on the direction of the gaze and zoom the target region on the touch screen display.

According to still another aspect of the present disclosure, a method for controlling display of a region on a touch screen display of a mobile device is disclosed. In this method, a first screen is displayed on the touch screen display including a touch screen sensor. A command to display a target region of the first screen at a different region in the touch screen display is received by a first sensor. Then, a second screen including the target region at the different region in the touch screen display is displayed.

### BRIEF DESCRIPTION OF THE DRAWINGS

Embodiments of the inventive aspects of this disclosure will be understood with reference to the following detailed description, when read in conjunction with the accompanying drawings.

FIG. 1 illustrates a mobile device configured to control display of a region on a touch screen display of the mobile device in response to a command received by a sensor, according to one embodiment of the present disclosure.

FIG. 2 illustrates a touch screen display of a mobile device displaying an object to be zoomed and a target region that is zoomed to include the object, according to one embodiment of the present disclosure.

FIG. 3 illustrates a mobile device including a microphone for receiving a command, according to one embodiment of the present disclosure.

FIG. 4 illustrates a mobile device including a touch sensor for receiving a command, according to one embodiment of the present disclosure.

FIG. 5 illustrates a mobile device including a pressure sensor for receiving a command, according to one embodiment of the present disclosure.

FIG. 6 illustrates a mobile device including an accelerometer for sensing a motion of the mobile device as a command, according to one embodiment of the present disclosure.

FIG. 7 illustrates a block diagram of a mobile device configured to control display of a region on a touch screen display of the mobile device in response to a command, according to one embodiment of the present disclosure.

FIG. 8 illustrates a block diagram of a sensor unit in a mobile device that includes a plurality of sensor devices for detecting a command, according to one embodiment of the present disclosure.

FIG. 9 is a flow chart of a method for controlling display of a region on a touch screen display of a mobile device in response to a command indicative of zooming, according to one embodiment of the present disclosure.

FIG. 10 is a flow chart of a method for controlling display of a region on a touch screen display of a mobile device in response to a command indicative of displaying the region at a different region in the touch screen display, according to one embodiment of the present disclosure.

FIG. 11 is a block diagram of an exemplary mobile device in which the methods and apparatus for controlling display of a region in the mobile device may be implemented, according to some embodiments of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the various embodiments.

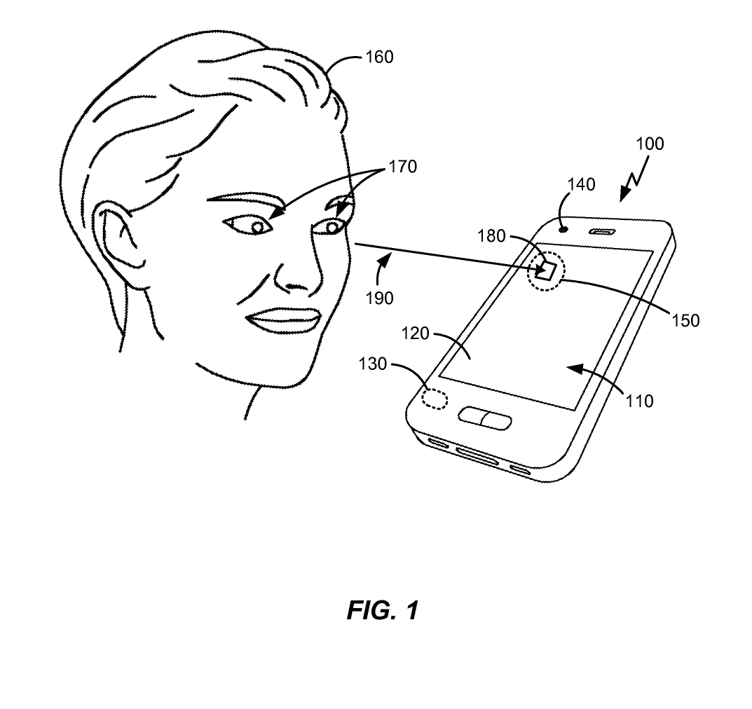

FIG. 1 illustrates a mobile device 100 configured to control display of a target region 150 on a touch screen display 110 of the mobile device 100, according to one embodiment of the present disclosure. The touch screen display 110 may include a touch screen sensor 120. In one embodiment, the touch screen sensor 120 may be configured to receive a touch input from a user 160.

According to another embodiment, the touch screen sensor 120 may include a proximity sensor that is configured to sense a proximate contact with an object that is located in close proximity to the touch screen display 110 without a physical contact. The proximity sensor may be implemented employing any suitable scheme for detecting presence of an object using, for example, an electromagnetic field or beam. In one embodiment, the proximity sensor may include one or more proximity sensing elements to detect a position, movement, etc. of an object. By sensing a proximate contact with an object (e.g., a finger of the user 160), the touch screen sensor 120 may sense or detect an act or operation of the user 160 that may be recognized as a command from the user 160. For example, a movement of a finger of the user 160 over the touch screen display 110 that is indicative of a command to zoom the target region 150 on the touch screen display 110 or display the target region 150 at a different region in the touch screen display 110 may be detected and recognized as the command.

The mobile device 100 may include a sensor unit 130 disposed in any suitable location in the mobile device 100. The sensor unit 130 is configured to sense or detect an act or operation of the user 160 that may be recognized as a command from the user 160. For example, a voice input, a touch input, a force or pressure input, a proximate contact with the touch screen display 110, or a movement of the mobile device 100 by the user 160 that is indicative of a command to zoom the target region 150 on the touch screen display 110 or display the target region 150 at a different region in the touch screen display 110 may be detected and recognized as the command. The sensor unit 130 may include a pressure sensor, a touch sensor, an accelerometer, a gyroscope, a microphone, and/or a proximity sensor, or any combination thereof.

The mobile device 100 may include a camera 140 configured to sense one or more images for use in determining the target region 150 on the touch screen display 110. When the user 160 performs the act or operation indicative of a command to zoom the target region 150 on the touch screen display 110 or display the target region 150 at a different region in the touch screen display 110, it may be assumed that the user 160 is looking at a specific object or region on the touch screen display 110. That is, a direction of a gaze from a pair of eyes 170 of the user 160 may correspond to the specific object or region on the touch screen display 110.

In one embodiment, the camera 140 may sense an image including the eyes 170 of the user 160 in response to receiving a command from the user 160. For example, when the user 160 performs an act or operation indicative of zooming while gazing at a specific object or region on the touch screen display 110, the camera 140 senses the image of the user 160 including at least the eyes 170. In the illustrated embodiment, the eyes 170 of the user 160 are gazing at an object 180 (e.g., an icon) in a corner of the touch screen display 110, which may also be displaying other objects, icons, or information. Additionally or alternatively, the camera 140 may sense one or more images including the eyes 170 of the user 160 regardless of a command from the user 160. For example, the camera 140 may periodically sense one or more images including the eyes 170 of the user 160.

From the sensed image including the eyes 170 of the user 160, a direction of a gaze 190 of the eyes 170 may be determined using any suitable gaze detection methods. For example, the direction of the gaze 190 may be determined based on a position of the iris or pupil of the eyes 170 in the sensed image. In one embodiment, a face or a head of the user 160 in the sensed image may also be analyzed in determining the direction of the gaze 190. In this process, any pattern recognition methods may be used to detect the face or the eyes 170 in the image. According to some embodiments, the camera 140 may also sense a plurality of images including the eyes 170 of the user 160 for use in determining the direction of the gaze 190.

Once the direction of the gaze 190 of the user 160 is determined, the mobile device 100 may determine the target region 150. In one embodiment, the mobile device 100 may identify the object 180 on the touch screen display 110 that corresponds to the direction of the gaze 190. The target region 150 may then be determined to include at least the identified object 180. The target region 150 including at least the identified object 180 may then be zoomed and displayed on the touch screen display 110 for the user 160. Alternatively, the target region 150 including at least the identified object 180 may be displayed at a different region in the touch screen display 110. In response to an input by the user 160 in the target region 150 of the touch screen display 110, the mobile device 100 may perform an additional operation associated with the input. Once the user 160 performs the additional operation or no operation for a predetermined period of time, the mobile device 100 may proceed to display a screen according to the additional operation or return to the original display screen.

In some embodiments, the mobile device 100 may determine the target region 150 based on an act or operation of the user 160 sensed by the touch screen sensor 120 or the sensor unit 130. The sensed act or operation of the user 160 such as a voice input, a touch input, a force or pressure input, a proximate contact with the touch screen display 110, or a movement of the mobile device 100 by the user 160 may indicate the target region 150. For example, if the detected movement of the mobile device 100 by the user 160 indicates an upper left-hand corner of the touch screen display 110 as the target region 150, the upper left-hand corner of the touch screen display 110 may be determined as the target region 150.

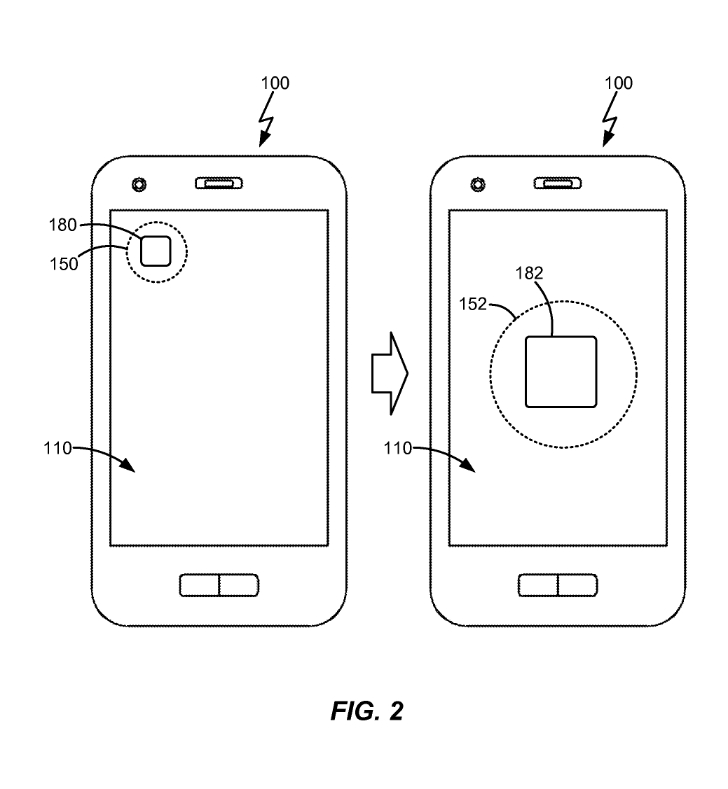

FIG. 2 illustrates the touch screen display 110 of the mobile device 100 displaying the object 180 to be zoomed and the target region 150 that is zoomed to include the object 180, according to one embodiment of the present disclosure. Initially, the object 180 is in an upper left-hand corner of the touch screen display 110 and thus it may not be convenient for the user 160 to reach or touch the object 180 with one hand. Accordingly, the user 160 may perform an act or operation indicative of zooming while gazing at the object 180.

The mobile device 100 may sense at least one image of the user 160 including a pair of eyes and determine the direction of the gaze 190 to the object 180 based on the at least one image. The mobile device 100 may then determine the target region 150 to include the object 180, and zoom the target region 150. The zoomed target region 152 including the zoomed object 182 may then be displayed on the touch screen display 110 for a touch input by the user 160.

According to some embodiments, the target region 150 may be zoomed and displayed near the original location of the object 180 or on a different region of the touch screen display 110. For example, the zoomed target region 152 may be centered in the touch screen display 110 as shown in FIG. 2. Alternatively, the zoomed target region 152 may be displayed in any region of the touch screen display 110.

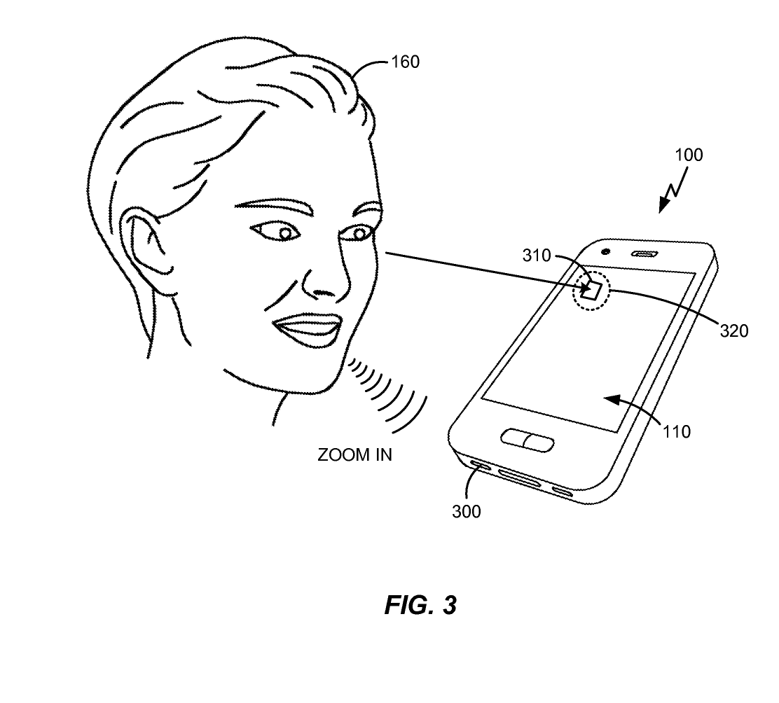

FIG. 3 illustrates the mobile device 100 including a microphone 300 for receiving a command, according to one embodiment of the present disclosure. The microphone 300 is configured to receive sound inputs of the user 160 indicative of commands. When a voice input received by the microphone 300 corresponds to a voice input indicative of a command to zoom a region on the touch screen display 110 or display a region at a different region in the touch screen display 110, the mobile device 100 may recognize the voice input as the command. For example, the user 160 may speak a voice command, “ZOOM IN,” indicative of zooming while looking at an object 310. The microphone 300 captures the voice command indicative of zooming In response to the voice command, the mobile device 100 may recognize the command to zoom and zoom a target region 320 including the object 310 for display on the touch screen display 110.

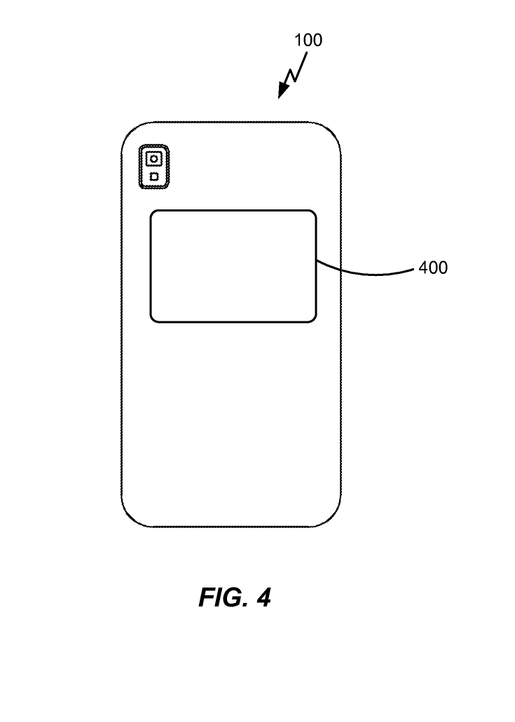

FIG. 4 illustrates the mobile device 100 including a touch sensor 400 for receiving a command, according to one embodiment of the present disclosure. The touch sensor 400 (e.g., a touch pad) may be disposed on any portion other than the touch screen display 110 of the mobile device 100. In the illustrated embodiment, the touch sensor 400 is disposed on a back portion of the mobile device 100 such that the user 160 may hold the mobile device 100 in one hand and touch the touch sensor 400 with one or more fingers on the same hand to input a command.

In one embodiment, the touch sensor 400 may be configured to receive a predetermined touch input of the user 160, such as a tap, tap pattern, swipe, swipe pattern, etc., that is indicative of the command to zoom a region on the touch screen display 110 or display a region at a different region in the touch screen display 110. For example, the user 160 may swipe the touch sensor 400 in a specific pattern or configuration (e.g., a swipe along a predefined direction, line, curve, or arc) indicative of zooming while looking at an object on the touch screen display 110. When such a touch input is received by the touch sensor 400, the mobile device 100 may recognize the touch input as the command to zoom. In response to the recognized command to zoom, the mobile device 100 may zoom a target region including the object and display the zoomed target region on the touch screen display 110.

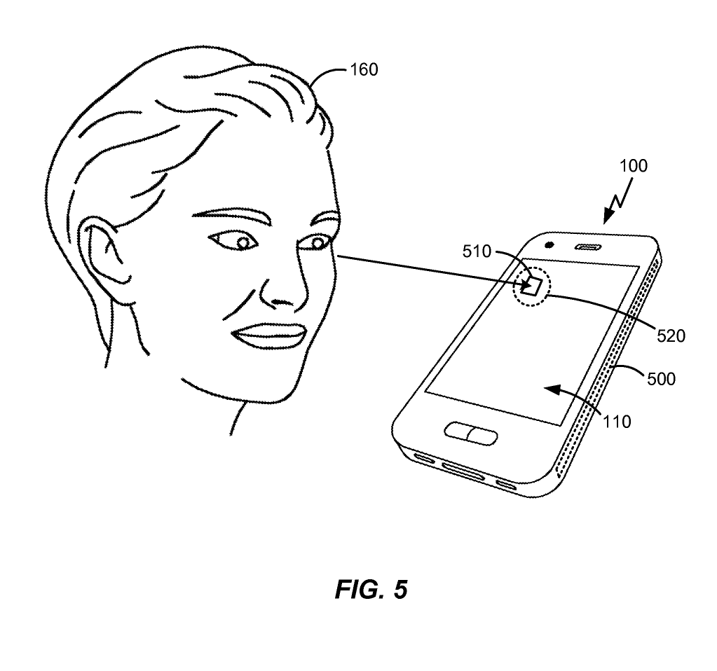

FIG. 5 illustrates the mobile device 100 including a pressure sensor 500 for receiving a command, according to one embodiment of the present disclosure. As shown, the pressure sensor 500 is disposed on a side portion of the mobile device 100 such that the user 160 may hold the mobile device 100 in one hand and press the pressure sensor 500 with one or more fingers on the same hand to input a command indicative of zooming a region on the touch screen display 110 or displaying a region at a different region in the touch screen display 110. Although the pressure sensor 500 is illustrated to be disposed on one side of the mobile device 100, the pressure sensor 500 may be disposed on any one or more sides of the mobile device 100.

While the user 160 is gazing at an object 510 on the touch screen display 110, the user 160 may press the pressure sensor 500 to zoom the object 510. In response, the pressure sensor 500 detects the applied force or pressure and the mobile device 100 may recognize the applied force or pressure as a command to zoom if the force or pressure exceeds a predetermined threshold force or pressure. In one embodiment, the user 160 may hold the mobile device 100 in one hand and press a predetermined location of the pressure sensor 500 to indicate a command for zooming while looking at the object 510. The pressure sensor 500 senses the force or pressure applied by the user 160 at the predetermined location and the mobile device 100 may recognize the command to zoom and zoom a target region 520 including the object 510 for display on the touch screen display 110.

According to another embodiment, the mobile device 100 may include one or more additional pressure sensors (not shown) on the opposite side of the pressure sensor 500, and the upper and lower sides of the mobile device 100. In this case, the mobile device 100 may be configured to recognize one or more forces or pressures applied on one or more predetermined locations of the pressure sensors to indicate a command for zooming a region on the touch screen display 110 or displaying a region at a different region in the touch screen display 110. For example, the user 160 may press an upper portion of the pressure sensor 500 and an upper portion of the pressure sensor on the opposite side of the mobile device 100 with a thumb and a forefinger, respectively. The applied forces or pressures may then be recognized by the mobile device 100 as a command to zoom.

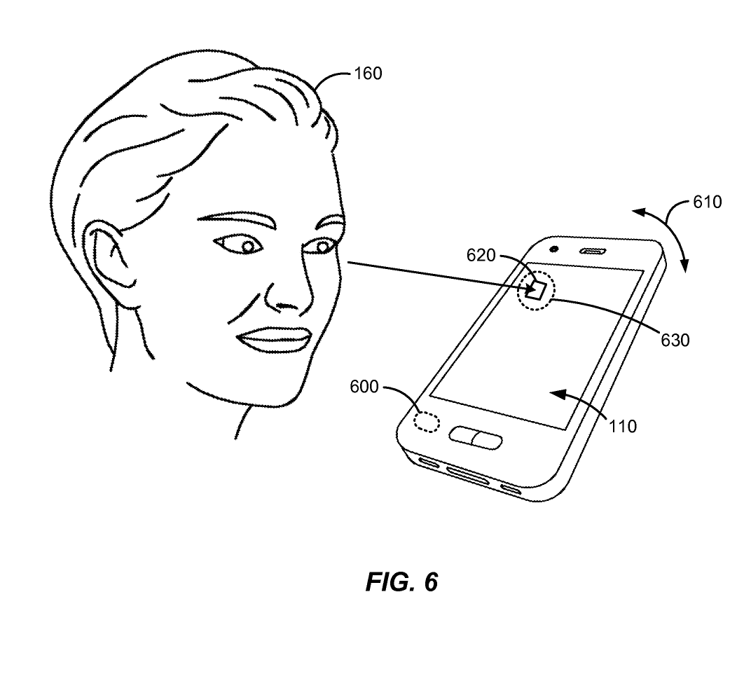

FIG. 6 illustrates the mobile device 100 including an accelerometer 600 for sensing a motion of the mobile device 100 as a command, according to one embodiment of the present disclosure. The accelerometer 600 is disposed within the mobile device 100 and may be located in any location for detecting motions of the mobile device 100. When a predetermined motion of the mobile device 100 indicative of a command to zoom a region on the touch screen display 110 or display a region at a different region in the touch screen display 110 is detected by the accelerometer 600, the mobile device 100 may recognize the motion as the command. For example, a motion of turning or rotating the mobile device 100 along a diagonal direction 610 may be configured as the predetermined motion indicative of zooming In response to sensing the predetermined motion by the accelerometer 600 when the user 160 is looking at an object 620 on the touch screen display 110, the mobile device 100 may recognize the motion as the command to zoom and zoom a target region 630 including the object 620 for display on the touch screen display 110.

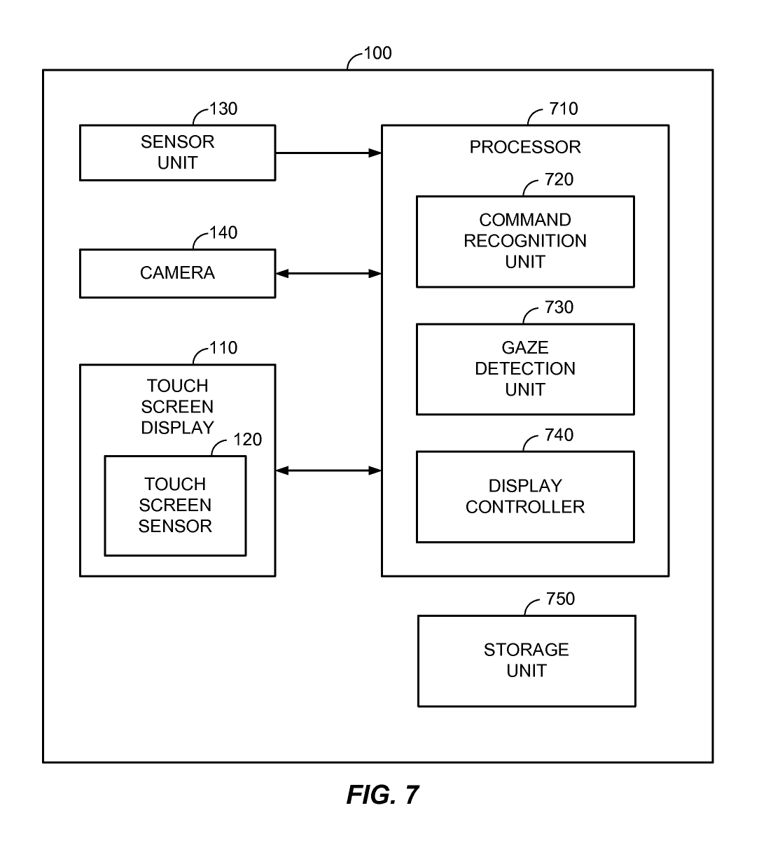

FIG. 7 illustrates a block diagram of the mobile device 100 configured to control display of a region on the touch screen display 110 of the mobile device 100 in response to a command, according to one embodiment of the present disclosure. The mobile device 100 may include the sensor unit 130, the camera 140, the touch screen display 110, a processor 710, and a storage unit 750. In the illustrated embodiment, the processor 710 may include a command recognition unit 720, a gaze detection unit 730 and a display controller 740. The processor 710 may be implemented using any suitable processing unit such as a central processing unit (CPU), an application processor, a microprocessor, or the like that can execute instructions or perform operations for the mobile device 100. The storage unit 750 stores data and instructions for operating the sensor unit 130, the camera 140, the touch screen display 110, and the processor 710, including predetermined criteria and threshold values for recognizing commands inputted by the user 160 via the sensor unit 130 and the touch screen display 110.

The sensor unit 130 in the mobile device 100 detects an act or operation of the user 160 indicative of a command to zoom a region on the touch screen display 110 or display a region at a different region in the touch screen display 110, and generates data associated with the detected act or operation. The sensor unit 130 may include one or more sensors for sensing the act or operation of the user 160 and output the data associated with the detected act or operation as detection data. In one embodiment, the touch screen sensor 120 may include a proximity sensor that detects an act or operation of the user 160 indicative of a command to zoom a region on the touch screen display 110 or display a region at a different region in the touch screen display 110, and generates data associated with the detected act or operation. The command recognition unit 720 receives the detection data from the sensor unit 130 or the touch screen sensor 120 and determines whether the detection data is indicative of the command to zoom a region on the touch screen display 110 or display a region at a different region in the touch screen display 110.

In one embodiment, the command recognition unit 720 may recognize the detection data as the command to zoom a region on the touch screen display 110 or display a region at a different region in the touch screen display 110 based on predetermined criteria or a threshold value for the detection data. If the detection data includes sound data, the command recognition unit 720 may recognize the sound data by extracting one or more sound features and comparing the extracted features with one or more predetermined sound features that are associated with a voice command and stored in the storage unit 750. For example, when sound data for a voice command “ZOOM IN” is received, one or more sound features may be extracted from the sound data. If a similarity between the extracted sound features and one or more predetermined sound features associated with the command “ZOOM IN” exceeds a predetermined threshold value, the sound data is recognized as the command to zoom.

For recognizing touch inputs on the touch sensor 400 as a command to zoom a region on the touch screen display 110 or display a region at a different region in the touch screen display 110, the storage unit 750 may store data for a plurality of predetermined touch patterns or configurations associated with a plurality of touch commands. A set of data may include coordinate data, direction data, etc. to indicate a predetermined touch pattern or configuration associated with a touch command. For example, a swipe along a predefined direction, line, curve, or arc may be defined and stored as a set of coordinate data indicating a zoom command. When the command recognition unit 720 receives coordinate data for the swipe input as detection data, it may access the predetermined data for the touch patterns or configurations from the storage unit 750. If the coordinate data is determined to correspond to the predetermined set of coordinate data associated with the zoom command, the command recognition unit 720 recognizes the swipe input as the zoom command. In determining whether the received detection data corresponds to a set of data for a predetermined touch pattern or configuration associated with a command, the command recognition unit 720 may recognize the detection data as the command if the detection data and the set of data for the command are within a specific threshold value.

The storage unit 750 may also store a threshold value for recognizing a force or pressure applied on the pressure sensor 500 as a command to zoom a region on the touch screen display 110 or display a region at a different region in the touch screen display 110. When the user 160 applies a force or pressure on the pressure sensor 500 for zooming, the command recognition unit 720 may receive the force or pressure data from the pressure sensor 500 and compare the force or pressure data with the threshold value for recognizing the force or pressure as a command to zoom. If the force or pressure data exceeds the threshold value, the command recognition unit 720 may recognize the force or pressure as a command to zoom. In one embodiment, the storage unit 750 may also store a position or coordinate value at a specific location in the pressure sensor 500 at which the force or pressure is applied. In this case, the zoom command may be recognized when the force or pressure is also determined to have been applied at the specific location.

The accelerometer 600 may be configured to detect a predetermined pattern of motion or acceleration of the mobile device 100 indicative of a command to zoom a region on the touch screen display 110 or display a region at a different region in the touch screen display 110. The storage unit 750 stores a predetermined set of data indicative of the pattern of motion or acceleration associated with the command. The predetermined set of data may include acceleration data with respect to X, Y, and Z axis, direction data, etc. to indicate a predetermined motion or acceleration associated with the command. For example, data for a motion of turning or rotating the mobile device 100 along a diagonal direction or shaking the mobile device 100 in a specific pattern may be associated with a zoom command and stored in the storage unit 750. When the command recognition unit 720 receives acceleration data from the accelerometer 600 as detection data, it may compare the detected acceleration data and the predetermined data from the storage unit 750 that is associated with the pattern or motion for the command to zoom. If the received acceleration data is determined to correspond to the predetermined set of data associated with the zoom command, the command recognition unit 720 may recognize the motion input as the zoom command. Additionally, the command recognition unit 720 may recognize the detection data as the command if the detection data and the predetermined set of data for the zoom command are also determined to be within a specific threshold value.

A motion indicative of the command to zoom a region on the touch screen display 110 or display a region at a different region in the touch screen display 110 may also be detected by a gyroscope. In this case, the storage unit 750 may store predetermined data indicating a pattern of change in orientation of the mobile device 100. For example, orientation data for a motion of the mobile device 100 in a specific pattern such as a tilting motion of the mobile device 100 may be associated with the zoom command and stored in the storage unit 750. When the user 160 tilts the mobile device 100 to indicate zooming, the gyroscope detects the tilting motion and outputs orientation data (e.g., pitch, roll, and yaw) in response to the tilting motion. The command recognition unit 720 receives orientation data as detection data, and compares the detected orientation data and the predetermined data from the storage unit 750 that is associated with the tilting motion for the zoom command. If the detected orientation data is determined to correspond to the predetermined orientation data associated with the zoom command, the command recognition unit 720 recognizes the motion as the zoom command Further, the command recognition unit 720 may recognize the detection data as the command if the detection data and the predetermined set of data for the zoom command are determined to be within a specific threshold value.

Once the detection data from the sensor unit 130 is recognized as the command to zoom a region on the touch screen display 110 or display a region at a different region in the touch screen display 110, the command recognition unit 720 may transmit a signal to instruct the camera 140 to sense one or more images including at least the eyes 170 of the user 160. In response, the camera 140 may sense one or more images of the user 160 including the eyes 170. The one or more sensed images are then sent to the gaze detection unit 730. In one embodiment, the one or more images sensed by the camera 140 also include the face or the head of the user 160. Although the illustrated mobile device 100 includes the camera 140, it may include any suitable number of cameras, image sensors, or video cameras for sensing one or more images of the user 160. Additionally or alternatively, the camera 140 may sense one or more images including the eyes 170 of the user 160 regardless of a signal from the command recognition unit 720. For example, the camera 140 may periodically sense one or more images including the eyes 170 of the user 160. The periodically sensed images may be sent to the gaze detection unit 730.

The gaze detection unit 730 receives the one or more sensed images from the camera 140 and may determine a direction of a gaze of the eyes 170 from the one or more sensed images based on a position of the iris or pupil of the eyes 170 relative to an eyeball or the face of the user 160. The gaze detection unit 730 then provides the determined direction of the gaze to the display controller 740. Based on the direction of the gaze, the display controller 740 determines a target region on the touch screen display 110. In one embodiment, the display controller 740 identifies an object or region on the touch screen display 110 that corresponds to the determined direction of the gaze and determines the target region to include at least the identified object or region. Once the target region is determined, the display controller 740 may zoom the target region including the identified object or region on the touch screen display 110 or display the target region at a different region in the touch screen display 110.

According to some embodiments, the display controller 740 may display the zoomed target region at any location on the touch screen display 110 that is adapted to facilitate access by the fingers of the hand with which the user 160 is holding the mobile device 100. In one embodiment, the display controller 740 displays the zoomed target region in a center portion of the touch screen display 110. Alternatively, the zoomed target region may be displayed in any portion of the touch screen display 110 that can be reached by a thumb or a finger of the hand holding the mobile device 100. In either case, the location in which the zoomed target region is displayed on the touch screen display 110 may be set by the user 160. After displaying the zoomed target region, the display controller 740 may return to displaying the original display screen, which was displayed immediately before displaying the zoomed target region, if a user input is not received within a predetermined period of time.

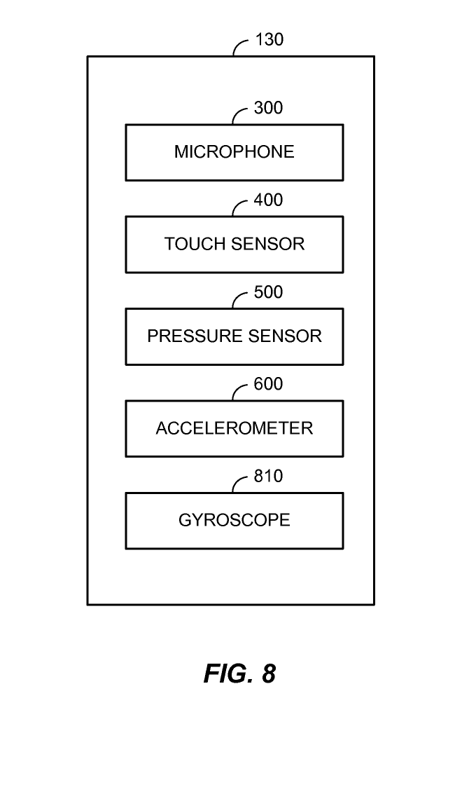

FIG. 8 illustrates a block diagram of the sensor unit 130 in the mobile device 100, according to one embodiment of the present disclosure. The sensor unit 130 may include the microphone 300, the touch sensor 400, the pressure sensor 500, the accelerometer 600, and a gyroscope 810. Additionally or alternatively, the sensor unit 130 may include any other types of sensors adapted to detect an act or an operation indicative of a command.

The microphone 300 in the sensor unit 130 is configured to receive a sound input such as a voice command (e.g., “ZOOM IN”) of the user 160 and convert the received sound into sound data. The sound data is then provided to the command recognition unit 720 as detection data for recognizing the sound data as a command. The microphone 300 may include any number of microphones or sound sensors for receiving sound inputs.

The touch sensor 400 receives a touch input of the user 160 (e.g., a swipe on the touch sensor 400) and converts the received touch into touch data such as coordinate data, direction data, etc. In one embodiment, the touch sensor 400 may include an array of touch sensing elements arranged to detect coordinates of the touch input from the user 160. The touch data is provided to the command recognition unit 720 for recognizing the touch data as a command. The touch sensor 400 may be implemented as a touchpad, a touchscreen, etc. and can be provided in any suitable location of the mobile device 100.

The pressure sensor 500 detects a force or pressure applied on the pressure sensor 500 by the user 160 and outputs force or pressure data (e.g., a magnitude of the force or pressure) in response to the applied force or pressure. In one embodiment, the pressure sensor 500 may include an array of force sensing elements arranged to detect a distribution of the applied force or pressure on the pressure sensor 500 by detecting a magnitude of a force or pressure applied to each force sensing element. The detected force or pressure data is then provided to the command recognition unit 720, which may recognize the force or pressure data as a command In one embodiment, the pressure sensor 500 may also detect a position or coordinate value at a specific location in the pressure sensor 500 at which the force or pressure is applied and provide the position or coordinate value to the command recognition unit 720 for recognizing the force or pressure data as a command.

The accelerometer 600 and the gyroscope 810 may be configured to detect a predetermined motion of the mobile device 100 indicative of a command. In the case of the accelerometer 600, when a user moves the mobile device 100 in a predetermined motion (e.g., pattern) indicative of zooming a region on the touch screen display 110 or displaying a region at a different region in the touch screen display 110, the acceleration of the mobile device 100 is detected and data for the detected acceleration is output to the command recognition unit 720. On the other hand, when the user 160 moves the mobile device in a predetermined motion (e.g., pattern) indicative of zooming a region on the touch screen display 110 or displaying a region at a different region in the touch screen display 110, the gyroscope 810 may detect orientation data (e.g., pitch, roll, and yaw) of the mobile device 100 and output the detected orientation data to the command recognition unit 720. The command recognition unit 720 may then recognize the detected acceleration data and/or the orientation data as a command based on a comparison to the predetermined motion data from the storage unit 750 associated with the command In one embodiment, the accelerometer 600 and the gyroscope 810 may operate continuously to detect acceleration and orientations of the mobile device 100. Although the accelerometer 600 and the gyroscope 810 are illustrated in the sensor unit 130, either or both may be used alone or in combination to detect the motion of the mobile device 100.

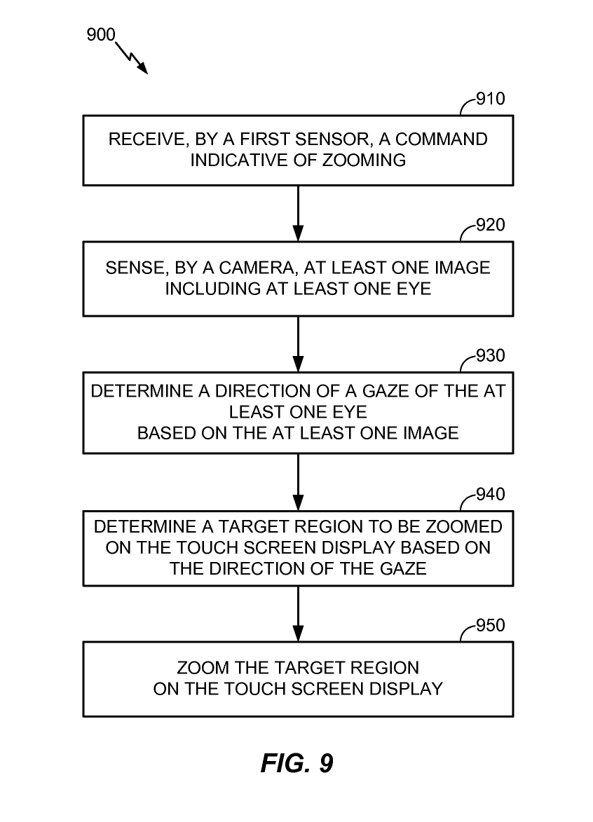

FIG. 9 is a flow chart of a method 900 for controlling display of a region on the touch screen display 110 of the mobile device 100, according to one embodiment of the present disclosure. The mobile device 100 receives a command indicative of zooming by a first sensor, at 910. For example, a voice input, a touch input, a force or pressure input, a proximate contact with the touch screen display 110, or a movement of the mobile device 100 by a user that is indicative of a command to zoom may be received by the first sensor. The first sensor may include a microphone, a touch sensor, a pressure sensor, an accelerometer, a gyroscope, and/or a proximity sensor, or any combination thereof.

The mobile device 100 may sense at least one image including at least one eye by the camera 140, at 920. For example, when the user performs an act or operation indicative of zooming while gazing at a specific object or region on the touch screen display 110, the camera 140 may sense the image of the user including at least one eye.

The mobile device 100 may determine a direction of a gaze of the at least one eye based on the at least one image, at 930. Based on the direction of the gaze, the mobile device 100 may determine a target region to be zoomed on the touch screen display 110, at 940. In one embodiment, the mobile device 100 may identify an object on the touch screen display 110 indicated by the direction of the gaze. The target region may then be determined to include at least the identified object.

The mobile device 100 may zoom the target region on the touch screen display 110, at 950. According to some embodiments, the target region may be zoomed and displayed near the original location of the object or on a different region of the touch screen display 110. For example, the zoomed target region may be centered in the touch screen display 110. Alternatively, the zoomed target region may be displayed in any region of the touch screen display 110.

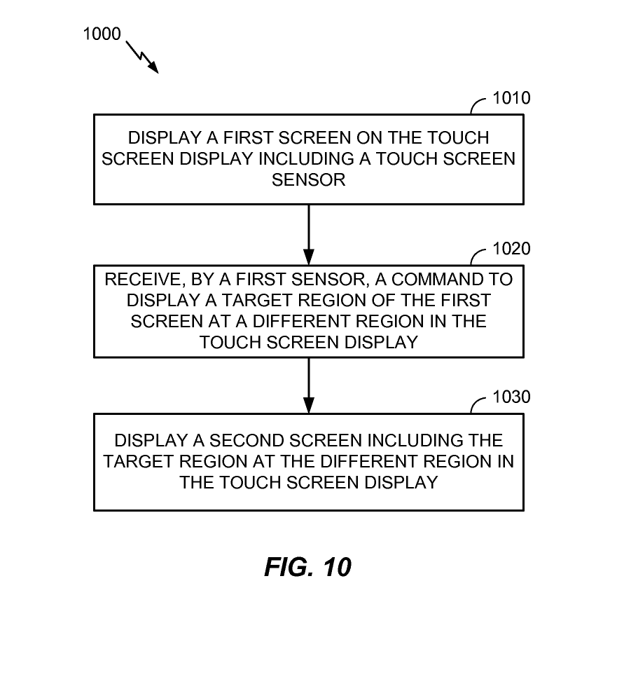

FIG. 10 is a flow chart of a method 1000 for controlling display of a region on the touch screen display 110 of the mobile device 100 in response to a command indicative of displaying the region at a different region in the touch screen display 110, according to one embodiment of the present disclosure. The mobile device 100 displays a first screen on the touch screen display 110 including the touch screen sensor 120, at 1010. The touch screen sensor 120 may be configured to receive a touch input from a user. Additionally, the touch screen sensor 120 may include a proximity sensor.

The mobile device 100 may receive a command to display a target region of the first screen at a different region in the touch screen display 110 by a first sensor, at 1020. For example, a voice input, a touch input, a force or pressure input, a proximate contact with the touch screen display 110, or a movement of the mobile device 100 by a user that is indicative of a command to display a target region of the first screen at a different region in the touch screen display 110 may be received by the first sensor. The first sensor may include a microphone, a touch sensor, a pressure sensor, an accelerometer, a gyroscope, and/or a proximity sensor, or any combination thereof. In one embodiment, the target region may be determined based on the received command by the first sensor. In another embodiment, a direction of a gaze of at least one eye may be determined based on at least one image including the at least one eye sensed by the camera 140, and the target region may be determined based on the direction of the gaze of the at least one eye.

The mobile device 100 may display a second screen including the target region at the different region in the touch screen display 110, at 1030. For example, the mobile device 100 may display the second screen including the target region that is centered in the touch screen display 110. Alternatively, the mobile device 100 may display the second screen including the target region that is located in any region of the touch screen display 110. In one embodiment, the mobile device 100 may display the second screen including the zoomed target region at the different region in the touch screen display 110.

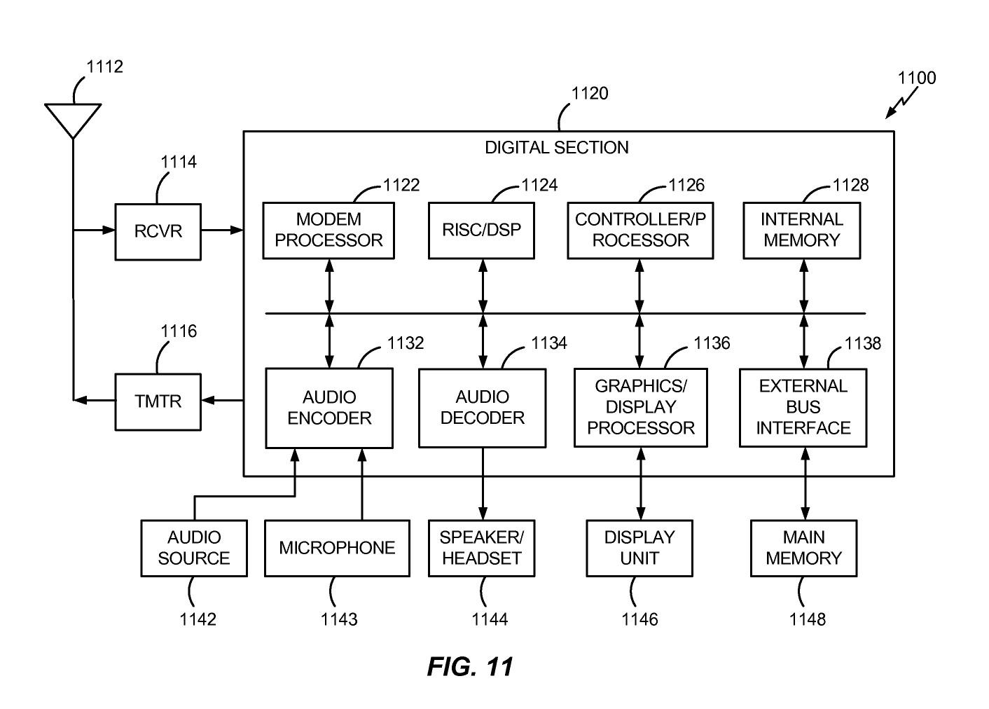

FIG. 11 is a block diagram of an exemplary mobile device 1100 in which the methods and apparatus for controlling display of a region in a mobile device may be implemented according to some embodiments of the present disclosure. The configuration of the mobile device 1100 may be implemented in the mobile devices according to the above embodiments described with reference to FIGS. 1 to 10. The mobile device 1100 may be a cellular phone, a smartphone, a phablet device, a tablet computer, a terminal, a handset, a personal digital assistant (PDA), a wireless modem, a cordless phone, etc. The wireless communication system may be a Code Division Multiple Access (CDMA) system, a Broadcast System for Mobile Communications (GSM) system, Wideband CDMA (WCDMA) system, Long Tern Evolution (LTE) system, LTE Advanced system, etc. Further, the mobile device 1100 may communicate directly with another mobile device, e.g., using Wi-Fi Direct, Bluetooth, or any peer-to-peer technology.

The mobile device 1100 is capable of providing bidirectional communication via a receive path and a transmit path. On the receive path, signals transmitted by base stations are received by an antenna 1112 and are provided to a receiver (RCVR) 1114. The receiver 1114 conditions and digitizes the received signal and provides samples such as the conditioned and digitized digital signal to a digital section for further processing. On the transmit path, a transmitter (TMTR) 1116 receives data to be transmitted from a digital section 1120, processes and conditions the data, and generates a modulated signal, which is transmitted via the antenna 1112 to the base stations. The receiver 1114 and the transmitter 1116 may be part of a transceiver that may support CDMA, GSM, LTE, LTE Advanced, etc.

The digital section 1120 includes various processing, interface, and memory units such as, for example, a modem processor 1122, a reduced instruction set computer/ digital signal processor (RISC/DSP) 1124, a controller/processor 1126, an internal memory 1128, a generalized audio encoder 1132, a generalized audio decoder 1134, a graphics/display processor 1136, and an external bus interface (EBI) 1138. The modem processor 1122 may perform processing for data transmission and reception, e.g., encoding, modulation, demodulation, and decoding. The RISC/DSP 1124 may perform general and specialized processing for the mobile device 1100. The controller/processor 1126 may perform the operation of various processing and interface units within the digital section 1120. The internal memory 1128 may store data and/or instructions for various units within the digital section 1120.

The generalized audio encoder 1132 may perform encoding for input signals from an audio source 1142, a microphone 1143, etc. The generalized audio decoder 1134 may perform decoding for coded audio data and may provide output signals to a speaker/headset 1144. The graphics/display processor 1136 may perform processing for graphics, videos, images, and texts, which may be presented to a display unit 1146. The EBI 1138 may facilitate transfer of data between the digital section 1120 and a main memory 1148.

The digital section 1120 may be implemented with one or more processors, DSPs, microprocessors, RISCs, etc. The digital section 1120 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein may be implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For a firmware and/or software implementation, the techniques may be embodied as instructions stored on a computer-readable medium, such as random access memory (RAM), read-only memory (ROM), non-volatile random access memory (NVRAM), programmable read-only memory (PROM), electrically erasable PROM (EEPROM), FLASH memory, compact disc (CD), magnetic or optical data storage device, or the like. The instructions may be executable by one or more processors and may cause the processor(s) to perform certain aspects of the functionality described herein.

If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if the software is transmitted from a website, a server, or other remote source using a coaxial cable, fiber optic cable, twisted pair, digital subscriber line (DSL), or wireless technologies such as infrared, radio, and microwave, then the coaxial cable, the fiber optic cable, the twisted pair, the DSL, or wireless technologies such as infrared, radio, and microwave are included in the definition of medium. Disk and disc, as used herein, includes CD, laser disc, optical disc, digital versatile disc (DVD), floppy disk and blu-ray disc where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. Alternatively, the storage medium may be integral to the processor. The processor and the storage medium may reside in an ASIC. The ASIC may reside in a user terminal Alternatively, the processor and the storage medium may reside as discrete components in a user terminal

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for controlling display of a region on a touch screen display of a mobile device, the method comprising:
receiving, by a first sensor, a command indicative of zooming;
sensing, by a camera, at least one image including at least one eye;
determining a direction of a gaze of the at least one eye based on the at least one image;
determining a target region to be zoomed on the touch screen display based on the direction of the gaze, wherein the touch screen display includes a touch screen sensor; and
zooming the target region on the touch screen display.

2. The method of claim 1, wherein determining the target region to be zoomed comprises:
identifying an object on the touch screen display indicated by the direction of the gaze; and
determining the target region to include the identified object.

3. The method of claim 1, wherein zooming the target region comprises displaying the target region on a different region of the touch screen display.

4. The method of claim 1, wherein receiving the command by the first sensor comprises receiving, by a pressure sensor, a pressure input indicative of the command.

5. The method of claim 1, wherein receiving the command by the first sensor comprises capturing, by a microphone, a voice input indicative of the command.

6. The method of claim 1, wherein receiving the command by the first sensor comprises detecting, by an accelerometer, a predetermined motion of the mobile device indicative of the command.

7. The method of claim 1, wherein receiving the command by the first sensor comprises detecting, by a gyroscope, a predetermined motion of the mobile device indicative of the command.

8. The method of claim 1, wherein receiving the command by the first sensor comprises detecting, by a touch sensor, a touch input indicative of the command, the touch sensor being disposed on a portion of the mobile device other than the touch screen display.

9. The method of claim 8, wherein the portion is a back portion of the mobile device.

10. The method of claim 1, wherein the first sensor is a multimodal sensor including at least two of a pressure sensor, a microphone, an accelerometer, a gyroscope, a touch sensor, and a proximity sensor.

11. A method for controlling display of a region on a touch screen display of a mobile device, the method comprising:
displaying a first screen on the touch screen display including a touch screen sensor;
receiving, by a first sensor, a command to display a target region of the first screen at a different region in the touch screen display; and
displaying a second screen including the target region at the different region in the touch screen display.

12. The method of claim 11, wherein displaying the second screen including the target region comprises zooming the target region at the different region in the touch screen display.

13. The method of claim 11, wherein receiving the command to display the target region of the first screen comprises:
sensing, by a camera, at least one image including at least one eye;
determining a direction of a gaze of the at least one eye based on the at least one image; and
determining the target region of the first screen based on the direction of the gaze.

14. The method of claim 11, wherein receiving the command by the first sensor comprises receiving, by a pressure sensor, a pressure input indicative of the command

15. The method of claim 11, wherein receiving the command by the first sensor comprises capturing, by a microphone, a voice input indicative of the command.

16. The method of claim 11, wherein receiving the command by the first sensor comprises detecting, by an accelerometer, a predetermined motion of the mobile device indicative of the command.

17. The method of claim 11, wherein receiving the command by the first sensor comprises detecting, by a touch sensor, a touch input indicative of the command, the touch sensor being disposed on a portion of the mobile device other than the touch screen display.

18. The method of claim 11, wherein the first sensor is a proximity sensor configured to sense a proximate contact with at least one portion of the touch screen display as the command.

19. The method of claim 18, wherein the touch screen sensor includes the proximity sensor.

20. The method of claim 11, wherein the first sensor is a multimodal sensor including at least two of a pressure sensor, a microphone, an accelerometer, a gyroscope, a touch sensor, and a proximity sensor.

21. A mobile device for controlling display of a region in the mobile device, the mobile device comprising:
a first sensor configured to receive an input indicative of a command to zoom;
a command recognition unit configured to recognize the command to zoom based on the input;
a camera configured to sense at least one image including at least one eye;
a gaze detection unit configured to determine a direction of a gaze of the at least one eye based on the at least one image;
a touch screen display having a touch screen sensor; and
a display controller configured to determine a target region to be zoomed on the touch screen display based on the direction of the gaze and zoom the target region on the touch screen display.

22. The mobile device of claim 21, wherein the display controller is further configured to:
identify an object on the touch screen display indicated by the direction of the gaze; and
determine the target region to include the identified object.

23. The mobile device of claim 21, wherein the display controller is further configured to display the target region on a different region of the touch screen display.

24. The mobile device of claim 21, wherein the first sensor includes a pressure sensor configured to receive a pressure input indicative of the command.

25. The mobile device of claim 21, wherein the first sensor includes a microphone configured to capture a voice input indicative of the command.

26. The mobile device of claim 21, wherein the first sensor includes an accelerometer configured to detect a predetermined motion of the mobile device indicative of the command.

27. The mobile device of claim 21, wherein the first sensor includes a gyroscope configured to detect a predetermined motion of the mobile device indicative of the command

28. The mobile device of claim 21, wherein the first sensor includes a touch sensor configured to detect a touch input indicative of the command, the touch sensor being disposed on a portion of the mobile device other than the touch screen display.

29. The mobile device of claim 28, wherein the portion is a back portion of the mobile device.

30. The mobile device of claim 21, wherein the first sensor is a multimodal sensor including at least two of a pressure sensor, a microphone, an accelerometer, a gyroscope, a touch sensor, and a proximity sensor.

31. A mobile device for controlling display of a region on a touch screen display of the mobile device, the mobile device comprising:
means for receiving, by a first sensor, a command indicative of zooming;
means for sensing, by a camera, at least one image including at least one eye;
means for determining a direction of a gaze of the at least one eye based on the at least one image;
means for determining a target region to be zoomed on the touch screen display based on the direction of the gaze, wherein the touch screen display includes a touch screen sensor; and
means for zooming the target region on the touch screen display.

32. The mobile device of claim 31, wherein the means for determining the target region is configured to:
identify an object on the touch screen display indicated by the direction of the gaze; and
determine the target region to include the identified object.

33. The mobile device of claim 31, wherein the means for zooming the target region is configured to display the target region on a different region of the touch screen display.

34. The mobile device of claim 31, wherein the first sensor includes a pressure sensor configured to receive a pressure input indicative of the command.

35. The mobile device of claim 31, wherein the first sensor includes a microphone configured to capture a voice input indicative of the command

36. The mobile device of claim 31, wherein the first sensor includes an accelerometer configured to detect a predetermined motion of the mobile device indicative of the command.

37. The mobile device of claim 31, wherein the first sensor includes a gyroscope configured to detect a predetermined motion of the mobile device indicative of the command

38. The mobile device of claim 31, wherein the first sensor includes a touch sensor configured to detect a touch input indicative of the command, the touch sensor being disposed on a portion of the mobile device other than the touch screen display.

39. The mobile device of claim 38, wherein the portion is a back portion of the mobile device.

40. The mobile device of claim 31, wherein the first sensor is a multimodal sensor including at least two of a pressure sensor, a microphone, an accelerometer, a gyroscope, a touch sensor, and a proximity sensor.

41. A non-transitory computer-readable storage medium comprising instructions for controlling display of a region on a touch screen display of a mobile device, the instructions causing a processor of the mobile device to perform the operations of:
receiving, by a first sensor, a command indicative of zooming;
sensing, by a camera, at least one image including at least one eye;
determining a direction of a gaze of the at least one eye based on the at least one image;
determining a target region to be zoomed on the touch screen display based on the direction of the gaze, wherein the touch screen display includes a touch screen sensor; and
zooming the target region on the touch screen display.

42. The storage medium of claim 41, wherein determining the target region to be zoomed comprises:
identifying an object on the touch screen display indicated by the direction of the gaze; and
determining the target region to include the identified object.

43. The storage medium of claim 41, wherein zooming the target region comprises displaying the target region on a different region of the touch screen display.

44. The storage medium of claim 41, wherein receiving the command by the first sensor comprises receiving, by a pressure sensor, a pressure input indicative of the command

45. The storage medium of claim 41, wherein receiving the command by the first sensor comprises capturing, by a microphone, a voice input indicative of the command.

46. The storage medium of claim 41, wherein receiving the command by the first sensor comprises detecting, by an accelerometer, a predetermined motion of the mobile device indicative of the command.

47. The storage medium of claim 41, wherein receiving the command by the first sensor comprises detecting, by a gyroscope, a predetermined motion of the mobile device indicative of the command.

48. The storage medium of claim 41, wherein receiving the command by the first sensor comprises detecting, by a touch sensor, a touch input indicative of the command, the touch sensor being disposed on a portion of the mobile device other than the touch screen display.

49. The storage medium of claim 48, wherein the portion is a back portion of the mobile device.

50. The storage medium of claim 41, wherein the first sensor is a multimodal sensor including at least two of a pressure sensor, a microphone, an accelerometer, a gyroscope, a touch sensor, and a proximity sensor.
